(19) United States
(12) Patent Application Publication
(10) Pub. No.: US 2006/0180081 A1
(43) Pub. Date: Aug. 17, 2006

(54) Semiconductor manufacturing apparatus having air curtain in door entrance

(76) Inventor: Young-ho Park, Suwon-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/190,117

(22) Filed: Jul. 27, 2005

(30) Foreign Application Priority Data
Nov. 22, 2004 (KR) 10-2004-0095889

(51) Int. Cl. B05C 11/00

(52) U.S. Cl. 118/666

(57) ABSTRACT

Disclosed is a semiconductor manufacturing apparatus having an air curtain located in a door entrance thereof. The air curtain is generated by an air curtain generator located in the door entrance of the apparatus. The air curtain typically flows into a discharge pipe located in the door entrance opposite the air curtain generator.

### BACKGROUND OF THE INVENTION

1. Field of the Invention

The present invention relates generally to a semiconductor manufacturing apparatus. More particularly, the invention relates to a semiconductor manufacturing apparatus having an air curtain in a door entrance thereof so as to prevent pollutants from diffusing into the semiconductor manufacturing apparatus.

A claim of priority is made to Korean Patent Application No. 10-2004-0095889 filed on Nov. 22, 2004, the disclosure of which is hereby incorporated by reference in its entirety.

2. Description of the Related Art

Semiconductor manufacturing processes are generally carried out in highly regulated environments to ensure that environmental contaminants such as chemicals and foreign particles do not interfere with the manufacturing processes. For example, highly integrated semiconductor devices formed on 300-mm wafers require highly sterile processing conditions to ensure that foreign particles do not cause any defects therein.

One way of providing such an environment for a semiconductor manufacturing process includes placing a semiconductor manufacturing apparatus in a clean room environment. A clean room environment typically comprises a volume of space wherein the number of airborne particles larger than a certain size is highly controlled.

Various Federal and International Standards define different levels of cleanliness for clean rooms. For example, United States Federal Standard 209, British Standard 5295, and International Standards Organization (ISO) Standard 14644 define clean room “classes” based on the number of particles per unit volume within a clean room. For instance, a class 1000 clean room according to Federal Standard 209 contains at most 1000 particles larger than 0.5 microns in a cubic foot of air. Similarly, a class 1 clean room according to Federal Standard 209 contains at most 1 particle larger than 0.5 microns in a cubic foot of air.

In addition to placing the semiconductor manufacturing apparatus within a clean room, processing conditions for semiconductor manufacturing processes can be further controlled by regulating the local environment within the semiconductor manufacturing apparatus. For example, the semiconductor manufacturing apparatus may comprise processing equipment installed within a case. The case allows semiconductor manufacturing processes to take place in an environment with an even higher level of cleanliness (e.g., a higher clean room class) than the clean room. The higher level of cleanliness is achieved by closing a door to the case and then filtering the air within the case to remove pollutants such as foreign particles and chemicals.

In order to filter the air within the case, the air pressure within the case is typically maintained at a higher level than the air pressure outside the case, i.e., the air pressure in the clean room. This prevents pollutants from flowing freely into the case.

Because of the difference in the cleanliness levels of the semiconductor manufacturing apparatus and the clean room, pollutants such as chemicals and other particles produced by the semiconductor manufacturing apparatus may flow into the clean room and pollutants in the clean room may flow into the semiconductor manufacturing apparatus during periodic preventive maintenance or general maintenance of the semiconductor manufacturing apparatus. Such a flow of pollutants between the clean room and the semiconductor manufacturing apparatus can cause general pollution of the semiconductor manufacturing apparatus and/or the inside of the clean room and it can lead to defects in devices formed by the semiconductor manufacturing apparatus and in the manufacturing apparatus itself. For example, environmental pollution is known to cause faultiness in a spinner used to perform spin coating of wafers.

FIG. 1 is a diagram illustrating a conventional semiconductor manufacturing apparatus installed in a clean room environment.

Referring to FIG. 1, a conventional semiconductor manufacturing apparatus is installed in a clean room environment 17. The semiconductor manufacturing apparatus includes a case 11 with a door part 10, and a processing part 20 installed in case 11. Processing part 20 performs a semiconductor manufacturing process on a wafer. Processing part 20 typically includes components for performing specific semiconductor manufacturing processes such as spin coating and so on.

A high efficiency particulate air (HEPA) filter 30 for managing and controlling pollutants (such as chemical fumes and the like) and/or particles is installed in an upper part of case 11. A fluid provided through HEPA filter 30 flows down in an inner environment 15 of case 11, gathers at a bottom portion 13 of case 11 and then flows out of case 11. HEPA filter 30 causes inner environment 15 to be maintained at a higher pressure than clean room environment 17. In other words, the semiconductor manufacturing apparatus exhibits positive pressure relative to clean room environment 17.

In many instances, case 11 does not completely isolate the inner environment 15 from clean room environment 17. For example, where door 10 is opened or gaps are formed in joints of case 11, air flows freely between inner environment 15 and clean room environment 17. Accordingly, pollutants including chemicals and foreign particles may be exchanged between clean room environment 17 and inner environment 15. As a result, inner environment 15 or clean room environment 17 or both may become contaminated by pollutants.

A particular instance where case 11 does not completely isolate inner environment occurs during periodic preventive maintenance or general maintenance of processing unit 20 where door 10 is opened. In such instances, it is practically impossible to prevent pollution from being introduced into inner environment 15 and clean room environment 17.

Due to at least the above mentioned practical difficulties associated with conventional methods and apparatuses used to maintain clean room environments for semiconductor manufacturing processes, new methods and apparatuses capable of preventing cross contamination between an inner environment and a clean room environment are needed.

### SUMMARY OF THE INVENTION

The present invention addresses the general need for an apparatus providing increased control of a processing environment for semiconductor manufacturing processes. The invention allows a processing environment to be controlled so that pollutants are not passed between a clean room environment and an inner environment of a semiconductor manufacturing apparatus.

According to one embodiment of the present invention, a semiconductor manufacturing apparatus comprises a case having a door entrance and a processing unit for processing a semiconductor wafer installed in the case. The apparatus further comprises an air curtain generator installed at a first portion of the door entrance and a discharge pipe installed at a second portion of the door entrance opposite the first portion. The first portion is preferably an upper portion of the door entrance and the second portion is preferably a lower portion of the door entrance.

The air curtain generator preferably generates an air curtain isolating an inner environment of the semiconductor manufacturing apparatus from an outer environment of the semiconductor manufacturing apparatus. The air curtain prevents pollutants from flowing between the outer and inner environments. The apparatus typically further comprises a door covering the door entrance so that the inner and outer environments are further isolated from each other.

Preferably, the outer environment comprises a clean room environment and the inner environment has a higher pressure and a higher level of cleanliness than the outer environment.

The air curtain generator typically comprises an air blower or the like installed on the inside of an upper portion of the door entrance. The air blower generally expels a clean gas including an inert component such as nitrogen gas.

The semiconductor manufacturing apparatus typically further comprises a HEPA filter causing a downward flow of air from the top of the case so as to maintain the cleanliness of the inner environment at a higher level (i.e., a level with fewer large particles per unit volume) than the outer environment and to maintain the pressure of the inner environment at a higher level than the outer environment.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIG. 1 is a diagram illustrating a conventional semiconductor manufacturing apparatus installed in a clean room;

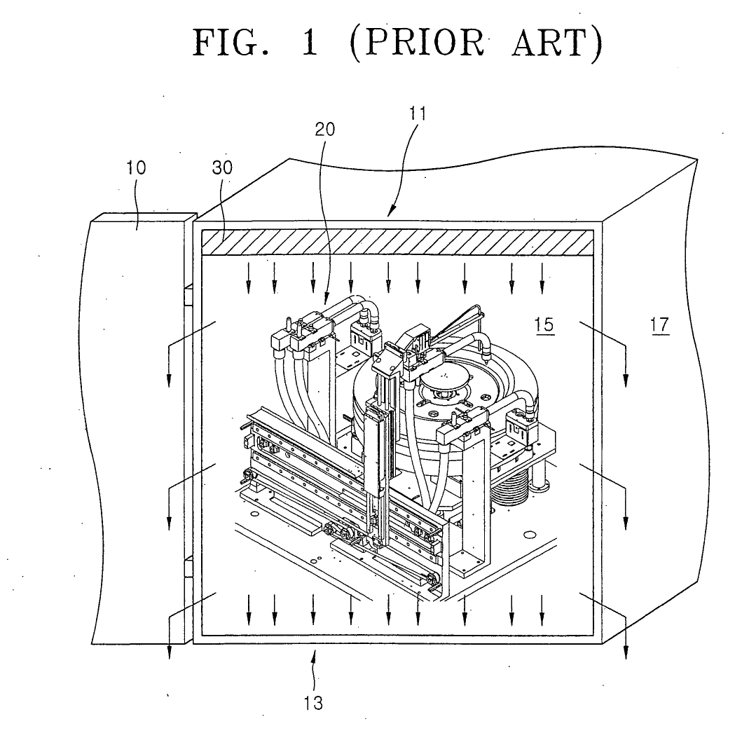

FIG. 2 is a cross-sectional side view of a semiconductor manufacturing apparatus installed in a clean room according to an embodiment of the present invention; and,

FIG. 3 is a front view of the semiconductor manufacturing apparatus shown in FIG. 2.

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

According to one embodiment of the invention, a semiconductor manufacturing apparatus is installed in a clean room. The semiconductor manufacturing apparatus comprises a case having a door entrance guarded by a door, and an air curtain (or air partition) installed inside the door entrance. The air curtain prevents any pollutants and/or particles generated by the semiconductor manufacturing apparatus from flowing into the clean room when the door is opened and it also prevents any pollutants and/or particles in the clean room from flowing into the case when the door is opened.

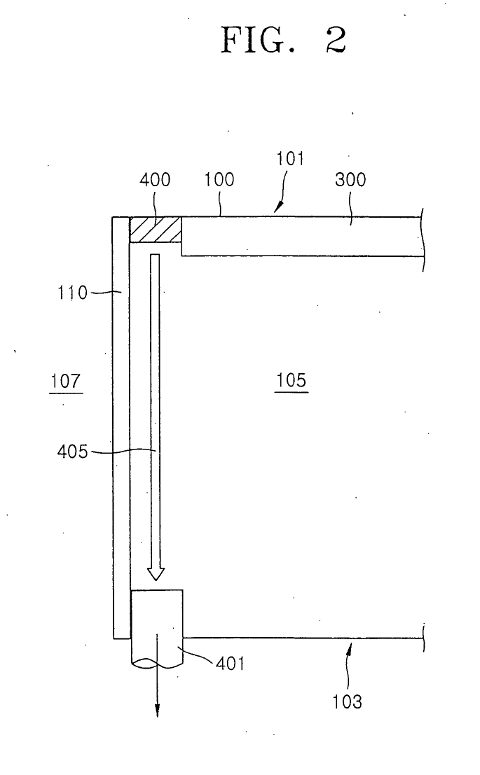

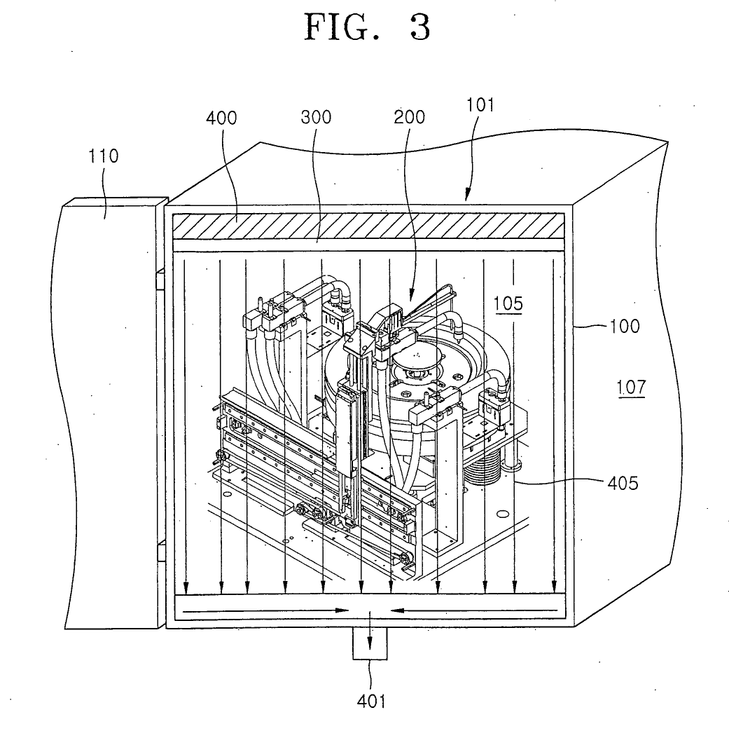

FIG. 2 is a cross-sectional side view of a semiconductor manufacturing apparatus installed in a clean room according to an embodiment of the present invention, and FIG. 3 is a front view of the semiconductor manufacturing apparatus shown in FIG. 2.

Referring to FIGS. 2 and 3, the semiconductor manufacturing apparatus comprises a case 100 having a door entrance and a door 110 attached to case 100 and guarding the door entrance. Door 110 separates an inner environment 105 of the semiconductor manufacturing device from an outer environment 107 of the semiconductor manufacturing device, usually a clean room.

Semiconductor manufacturing apparatus is typically constructed with a positive-pressure design, meaning that inner environment 105 is maintained at a higher pressure than outer environment 107. This is done so that inner environment 105 can be maintained at a higher level of cleanliness than outer environment 107. For example, outer environment 107 may be maintained at a class-1000 cleanliness level, while inner environment 105 is maintained at a class-1 cleanliness level.

A HEPA filter 300 installed on an upper part 101 of the inside of case 100 is generally used to maintain the cleanliness of inner environment 105. HEPA filter 300 provides clean air for inner environment 105 by supplying a downward flow of fluid to the case. The fluid generally flows to the bottom of the case, gathers at the bottom, and flows out of the case. In addition to providing a clean environment, HEPA filter 300 may also maintain the pressure of the inner environment at a level greater than the pressure of the outer environment.

The semiconductor manufacturing apparatus typically includes a processing unit 200 installed in case 100. Processing unit 200 performs manufacturing process(es) on a wafer. Processing unit 200 may comprise, for example, a device made by assembling components for loading/unloading a wafer and components used for processing wafers, such as a wafer table, a wafer chuck, and so on. Processing unit 200 may additionally comprise, for example, a spinner for performing spin coating on a loaded wafer.

In order to perform maintenance on processing unit 200, a worker typically opens door 110. For example, FIG. 3 shows the semiconductor manufacturing apparatus with door 110 open. In contrast, FIG. 2 shows the semiconductor manufacturing apparatus with door 110 closed.

Where door 110 is closed, it covers the door entrance as shown in FIG. 2. Accordingly, inner environment 105 is substantially physically isolated from outer environment 107. However, where door 110 is opened for maintenance, inner environment 105 and outer environment 107 exchange particles more freely. In order to prevent particle exchange from occurring between inner and outer environments 105 and 107, an air curtain 405 is generated in the door entrance of case 100 so that inner environment 105 is isolated from outer environment 107 even when door 110 is opened.

Air curtain 405 is generated by an air curtain generator 400 installed at upper part 101 of case 100. Air curtain generator 400 generates continuous airflow between an upper portion of case 100 and a discharge pipe 401 located at a lower portion of case 100. Discharge pipe 401 continuously discharges, or removes, airflow generated by air curtain generator from case 100. Once discharged from case 100, the airflow can either be recycled by air curtain generator 400 or exhausted to another location, e.g., a location outside of outer environment 107.

Air curtain generator 400 typically comprises an air blower such as a fan or a jet. Discharge pipe 401 is typically connected to a device adapted to discharge a flow of air such as, for example, a vacuum pump or some other air suction device. Those skilled in the art will understand that there are various additional and alternative ways of generating and discharging a flow of air.

Air curtain 405 typically comprises a stream of clean air (i.e., air of a cleanliness level compatible with the cleanliness level of the inner environment) such as a purified inert gas, e.g., nitrogen gas or the like. The use of a purified inert gas prevents the airflow from interfering with any semiconductor manufacturing processes performed in case 100.

Air curtain 405 prevents pollutants including chemicals, particles, and so on from flowing between inner environment 105 and outer environment 107 while door 110 is open. This prevents defects from occurring in semiconductor devices manufactured by the semiconductor manufacturing apparatus due to interference from the pollutants.

Although FIGS. 2 and 3 show air curtain generator 400 installed at an inside portion of upper part 101 next to the door entrance of case 100, air curtain generator 400 may also be installed outside of case 100. This may occur, for example, in cases where air curtain 405 is formed to cover the door entrance instead of door 110, i.e., where door 110 is not present. Furthermore, in order to prevent pollutants from flowing through gaps that may exist in joints between inner walls of case 100, air curtain 405 may be extended from the door entrance to side and/or rear parts of case 100. In other words, the position of air curtain generator 400 can be changed depending on the design and configuration of the semiconductor manufacturing apparatus. Also, the range, or thickness of air curtain 405 can be extended or condensed depending on the design and configuration of the semiconductor manufacturing apparatus.

As described above, the present invention makes it possible to prevent pollutants such as chemicals, particles, and so forth from flowing between an inner environment of a semiconductor manufacturing apparatus and a clean room. An air curtain prevents the pollutants from flowing between the clean room and the inner environment of the semiconductor manufacturing apparatus, even when a door of the semiconductor manufacturing apparatus is opened. Accordingly, pollution within the semiconductor manufacturing apparatus and/or a work environment of the clean room is efficiently minimized.

What is claimed:

1. A semiconductor manufacturing apparatus adapted for use in a clean room, comprising:
a case comprising a door entrance;
a processing unit installed in the case and adapted to process a semiconductor wafer; and, an air curtain generator installed at a first portion of the door entrance and adapted to generate an air curtain isolating the case from the clean room.

2. The apparatus of claim 1, further comprising a door adapted to cover the door entrance.

3. The apparatus of claim 1, wherein the first portion is an upper portion of the door entrance.

4. The apparatus of claim 1, further comprising a discharge pipe installed at a second portion of the door entrance opposite the first portion.

5. The apparatus of claim 4, wherein the air curtain comprises a flow of clean gas comprising at least one inert gas.

6. The apparatus of claim 5, wherein the clean gas comprises nitrogen gas.

7. The apparatus of claim 4, wherein the air curtain generator comprises an air blower.

8. The apparatus of claim 1, wherein the air curtain generator extends across the door entrance to sidewalls of the case, such that the air curtain extends to the sidewalls of the case.

9. The apparatus of claim 1, further comprising:
a high efficiency particulate air (HEPA) filter located in an upper portion of the case and producing a downward flow of fluid in the case, thereby maintaining an inner environment for the case at a higher cleanliness level and pressure than the clean room.

10. The apparatus of claim 1, wherein the processing unit comprises a spinner adapted to spin-coat the semiconductor wafer.

11. A semiconductor manufacturing apparatus adapted for use in a clean room, comprising:
a case having a door entrance;
a processing unit installed in the case and adapted to process a semiconductor wafer;
an air curtain generator installed at a first portion of the door entrance; and,
a discharge pipe installed at a second portion of the door entrance opposite the first portion;
wherein the air curtain generator generates an air curtain isolating an inner environment of the case from the clean room.

12. The apparatus of claim 11, further comprising a door adapted to cover the door entrance.

13. The apparatus of claim 12, wherein the first portion is an upper portion of the door entrance and the second portion is a lower portion of the door entrance.

14. The apparatus of claim 13, wherein the inner environment is maintained at a higher pressure than the clean room.

15. The apparatus of claim 14, wherein the inner environment is maintained at a higher cleanliness level than the clean room.

16. The apparatus of claim 10, wherein the air curtain generator generates an air flow comprising a clean gas including nitrogen gas.

17. The apparatus of claim 13, wherein the inner environment is a class 1 clean room and the clean room is a class 1000 clean room.
